(19) United States
(12) Patent Application Publication
(10) Pub. No.: US 2023/0104226 A1
(43) Pub. Date: Apr. 6, 2023

(54) ELECTRICALLY DISSIPATIVE POLYURETHANE FOAMS AND USE THEREOF IN TRENCH BREAKERS OR PIPELINE PILLOWS

(71) Applicant: BASF SE, Ludwigshafen am Rhein (DE)

(72) Inventors: Louis FARKAS, Wyandotte, MI (US); Yue YANG, Wyandotte, MI (US); Sam KHARCHENKO, Wyandotte, MI (US)

(21) Appl. No.: 17/907,339

(22) PCT Filed: May 14, 2021
(86) PCT No.: PCT/EP2021/062800

§ 371 Date: Sep. 26, 2022

Related U.S. Application Data
(60) Provisional application No. 63/024,802, filed on May 14, 2020.

(30) Foreign Application Priority Data
Jun. 10, 2020 (EP) 20179153.0

(51) Int. Cl. C08G 18/20; C08K 3/04; C08L 75/04; C08G 18/08; C08G 18/48

(52) U.S. Cl. CPC C08G 18/20; C08K 3/04; C08L 75/04; C08G 18/14; C08G 18/485; C08K 2201/006; C08G 2101/00

(57) ABSTRACT

Described herein is an electrically dissipative polyurethane foam and a method of using the electrically dissipative polyurethane foam in trench breakers or pipeline pillows.

### FIELD OF INVENTION

The present invention relates to an electrically dissipative polyurethane foam (PU foam) and its use in trench breakers or pipeline pillows.

### BACKGROUND OF THE INVENTION

Polyurethanes, defined as polymeric substances having multiple urethane linkages, belong to a large family of polymers with widely ranging properties and uses. Types of polyurethanes include rigid, semi-rigid and flexible foams; thermoplastic polyurethane; and other miscellaneous types, such as coatings, adhesives, sealants and elastomers. Flexible foams (e.g. that found in most car cushions) are generally open-celled materials, while rigid foams (e.g. building insulation) usually have a high proportion of closed cells. Semi-rigid foams have properties and applications intermediate to rigid and flexible foams.

One growing application of PU foams is their use as static dissipative materials. These materials allow the flow of static electric charges intermediate to those of anti-static and conductive materials. In particular, the dissipative materials allow the charges to flow to ground more slowly in a controlled manner than with conductive materials. These materials are typically used to prevent discharge to and from human contact. The human body being a high conductor of energy, can easily create a static spark. A plastic static dissipative material causes that spark to flow slower, emitting a lower energy to the ground to prevent discharge and possible damage to any sensitive items, thereby making them the ideal material for objects that experience frequent human contact.

PU foams with electrically conductive properties have been described in U.S. Pat. No. 4,231,901. The PU foam described here finds application in electronics-manufacturing facility, as well as in shipping electronic devices. The foam comprises an open-cell, impregnable PU foam which is impregnated with an elastomeric-type binder containing in part a film-forming polymer, along with an antistatic or electrically conductive amount of finely divided, particulate, carbon-black particles dispersed about and generally uniformly throughout the impregnated urethane foam.

Another U.S. Pat. No. 4,526,952 describes antistatic or electrically conductive thermoplastic polyurethane elastomers with good mechanical properties by means of an economical process. The carbon black was incorporated into the thermoplastic polyurethane elastomer at temperatures below the melting point peak of the rigid crystalline segments.

Cathodic protection for controlling the corrosion of metallic structures in various environments, makes use of the static dissipative materials. In a cathodic protection system, the pipeline acts as the cathode (negatively charged), and sheets of metal buried near the pipeline act as the anode (positively charged). Once the circuit is completed by being attached to a rectifier, the buried metal sheets act as a sacrificial anode which preferentially corrode over the cathode, pipeline, thus protecting the pipeline against corrosion. While coating has been previously used for preventing corrosion, the fact that these coatings have defects as thermal expansion leads to cracking renders them unsuitable for this application. Since PU foams are good insulators, they have been used for this application as well.

PU foams for trench breakers are described in U.S. Pat. No. 8,568,061 B2. In particular, floatation resistant foam with sufficient strength and density to provide stability and inhibit erosion at pipeline trench sites are described. The PU foam suitable for use in trench breaker has at least 50% open cell, a density of 1.3 lb/ft³ to 3.50 lb/ft³, a minimum compressive strength of 17 psi parallel to the rise of the foam, and exhibits a buoyancy loss of at least 20% after 24 hours of testing under 10 feet of water.

Electrically conductive PU foams are described in U.S. Pat. No. 10,259,923 B1. Use of carbon nanomaterials comprising isocyanate treated nanoplatelets formed by exfoliating graphite oxide nanoplatelets from isocyanate-treated graphite oxide in a dispersing medium is suggested for mitigation of corrosion in pipelines.

The existing PU foams lack any disclosure for having electrical resistivity in the static dissipative range, i.e. 1.0×10² Ω·m to 1.0×10⁹ Ω·m, as determined according to ASTM D257-14. Also, the existing PU foams tend to act as an electrical shield to the cathodic protection current, making the sacrificial anode method ineffective. With carbon based fillers as suitable ingredients to control the insulative property of the PU foam, there were still some limitations, particularly owing to their nano size. One such limitation was that the nanoparticles easily aggregate together, thus limiting the chance of the formation of an electrical pathway of filler in the foam. Also, the presence of nanoparticles influenced the foam formation by affecting the processing parameters, thereby resulting in inferior mechanical properties in the final PU foam.

It was, therefore, an object of the present invention to provide a PU foam formulation having electrical resistivity in the static dissipative range with acceptable mechanical properties, thereby rendering it useful for static dissipative materials, particularly for trench breakers or pipeline pillows.

### SUMMARY OF THE INVENTION

Surprisingly, it has been found that the above-identified object is met by providing a PU foam which is obtained by reacting a mixture comprising at least one isocyanate component, a first polyether polyol having a nominal functionality in between 2.0 to 3.5 and OH value in between 450 mg KOH/g to 600 mg KOH/g as the at least one isocyanate reactive component, 1.0 wt. % to 15.0 wt. % of carbon black having a BET surface area in between 600 m²/g to 1200 m²/g, at least one blowing agent, and at least one amine catalyst.

Accordingly, in one aspect, the presently claimed invention is directed to a PU foam which is obtained by reacting a mixture comprising:

(A) at least one isocyanate component,

(B) at least one isocyanate reactive component comprising a first polyether polyol having a nominal functionality in between 2.0 to 3.5 and OH value in between 450 mg KOH/g to 600 mg KOH/g,

(C) carbon black having a BET surface area in between 600 m²/g to 1200 m²/g,

(D) at least one blowing agent, and

(E) at least one amine catalyst,

wherein the amount of carbon black (C) is in between 1.0 wt. % to 15.0 wt. % based on the total weight of the mixture.

In another aspect, the presently claimed invention is directed to a process for preparing the above PU foam.

In still another aspect, the presently claimed invention is directed to the use of the above PU foam for static dissipative materials.

In yet another aspect, the presently claimed invention is directed to a method for producing a composite structure comprising the above PU foam.

In a further aspect, the presently claimed invention is directed to a trench breaker or pipeline pillow comprising the above PU foam.

In another aspect, the presently claimed invention is directed to a method of supporting trench pipes using the above PU foam.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

PU foam

An aspect of the present invention is embodiment 1, directed towards a PU foam which is obtained by reacting a mixture comprising:

(A) at least one isocyanate component,

(B) at least one isocyanate reactive component comprising a first polyether polyol having a nominal functionality in between 2.0 to 3.5 and OH value in between 450 mg KOH/g to 600 mg KOH/g,

(C) carbon black having a BET surface area in between 600 m²/g to 1200 m²/g,

(D) at least one blowing agent, and

(E) at least one amine catalyst,

wherein the amount of carbon black (C) is in between 1.0 wt. % to 15.0 wt. % based on the total weight of the mixture.

In one embodiment, the PU foam in the embodiment 1 is a rigid PU foam characterized with a foam density in between 20 kg/m³ to 150 kg/m³, as determined according to ASTM D1622 and an electrical resistivity in the static dissipative range, i.e. 1.0×10² Ω·m to 1.0×10⁹ Ω·m, as determined according to ASTM D257-14. In another embodiment, the density of the PU foam in embodiment 1 is in between 20 kg/m³ to 100 kg/m³, or 20 kg/m³ to 80 kg/m³, or 20 kg/m³ to 50 kg/m³.

In the present context, OH value is determined according to DIN 53240.

In an embodiment, the mixture in the embodiment 1 does not contain any other carbon-based fillers, except carbon black having BET surface area in between 600 m²/g to 1200 m²/g. In particular, no carbon nanotubes, graphite, and/or graphene are present in the mixture in the embodiment 1.

Isocyanate Component (A)

In one embodiment, the isocyanate component in the embodiment 1 comprises an aromatic isocyanate or an aliphatic isocyanate. It is to be understood that the isocyanate includes both monomeric and polymeric forms of the aliphatic or aromatic isocyanate. By the term “polymeric”, it is referred to the polymeric grade of the aliphatic or aromatic isocyanate comprising, independently of each other, different oligomers and homologues.

In an embodiment, the aliphatic isocyanate is selected from tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocyanatomethylcyclohexane isocyanates, isocyanatoethylcyclohexane isocyanates, bis(isocyanatomethyl)-cyclohexane diisocyanates, 4,4′-diisocyanatodicyclohexylmethane, pentamethylene 1,5-diisocyanate, isophorone diisocyanate and mixtures thereof.

In one embodiment, the isocyanate component in the embodiment 1 comprises an aromatic isocyanate. In another embodiment, the isocyanate component in the embodiment 1 consists of the aromatic isocyanate only.

Suitable aromatic isocyanate is selected from toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate and 1,3,5-triisopropyl benzene-2,4,6-triisocyanate.

In another embodiment, the aromatic isocyanate is selected from toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate. In yet other embodiment, the aromatic isocyanate is selected from toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate. In still other embodiment, the aromatic isocyanate is selected from toluene diisocyanate; polymeric toluene diisocyanate, methylene diphenyl diisocyanate and/or polymeric methylene diphenyl diisocyanate; m-phenylene diisocyanate. In a further embodiment, the aromatic isocyanate is selected from methylene diphenyl diisocyanate and/or polymeric methylene diphenyl diisocyanate.

In one embodiment, the isocyanate component in the embodiment 1 consists of methylene diphenyl diisocyanate and/or polymeric methylene diphenyl diisocyanate.

Methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate can be classified into monomeric methylene diphenyl diisocyanate and polymeric methylene diphenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2.0. The isomeric ratio as well as the amount of oligomeric species can vary in wide ranges in these products. For instance, polymeric methylene diphenyl diisocyanate may typically contain 30 wt.-% to 80 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

Isocyanate Reactive Component (B)

In an embodiment, the isocyanate reactive component in the embodiment 1 comprises a first polyether polyol having a nominal functionality in between 2.0 to 3.5 and OH value in between 450 mg KOH/g to 600 mg KOH/g.

In an embodiment, the nominal functionality of the first polyether polyol in the embodiment 1 is in between 2.0 to 3.4, or in between 2.1 to 3.4, or in between 2.1 to 3.3, or in between 2.2 to 3.3. In another embodiment, it is in between 2.2 to 3.2, or in between 2.3 to 3.2, or in between 2.3 to 3.1, or in between 2.4 to 3.1. In a still another embodiment, it is in between 2.5 to 3.1, or in between 2.6 to 3.1, or in between 2.7 to 3.1. In yet another embodiment, it is in between 2.8 to 3.1, or in between 2.9 to 3.1.

In one embodiment, the OH value of the first polyether polyol in the embodiment 1 is in between 450 mg KOH/g to 590 mg KOH/g. In another embodiment, it is in between 450 mg KOH/g to 580 mg KOH/g, or in between 450 mg KOH/g to 570 mg KOH/g, or in between 460 mg KOH/g to 570 mg KOH/g, or in between 460 mg KOH/g to 560 mg KOH/g, or in between 470 mg KOH/g to 560 mg KOH/g. In another embodiment, it is in between 470 mg KOH/g to 550 mg KOH/g, or in between 480 mg KOH/g to 550 mg KOH/g, or in between 480 mg KOH/g to 540 mg KOH/g, or in between 480 mg KOH/g to 530 mg KOH/g. In still another embodiment, it is in between 480 mg KOH/g to 520 mg KOH/g, or in between 490 mg KOH/g to 520 mg KOH/g.

Suitable first polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that the nominal functionality of the resulting polyether polyol is in between 2.0 to 3.5. Optionally, a mixture of suitable starter molecules is also used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

In one embodiment, amine containing starter molecules are selected from ethylenediamine, phenylenediamines, toluenediamine and isomers thereof.

Hydroxyl-containing starter molecules are selected from trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene oxides can be used singly, alternatingly in succession or as mixtures. In one embodiment, the alkylene oxides are propylene oxide and/or ethylene oxide. In other embodiment, the alkylene oxides are mixtures of ethylene oxide and propylene oxide that comprise more than 50 wt.-% of propylene oxide.

In one embodiment, the first polyether polyol in the embodiment 1 is based on ethanolamine and a mixture of ethylene oxide and propylene oxide, with a nominal functionality ranging between 2.9 to 3.1 and OH value in between 490 mg KOH/g to 520 mg KOH/g.

In one embodiment, the first polyether polyol in the embodiment 1 is present in between 50 wt. % to 90 wt. %, based on the total weight of the isocyanate reactive component. In another embodiment, it is present in between 50 wt. % to 85 wt. %, or 55 wt. % to 85 wt. %, or 55 wt. % to 80 wt. %. In yet another embodiment, it is present in between 60 wt. % to 80 wt. %, or 60 wt. % to 75 wt. %.

In an embodiment, the isocyanate reactive component in the embodiment 1 further comprises a second polyol selected from a polyester polyol, a second polyether polyol, a polymer polyol, and a mixture thereof.

Suitable polyester polyols have a nominal functionality in between 1.9 to 3.5 and OH value in between 250 mg KOH/g to 400 mg KOH/g. In one embodiment, the nominal functionality is in between 1.9 to 3.4, or in between 2.0 to 3.4, or in between 2.0 to 3.3, or in between 2.1 to 3.3.

In another embodiment, it is in between 2.1 to 3.2, or in between 2.1 to 3.1, or in between 2.1 to 3.0. In yet another embodiment, it is in between 2.2 to 3.0, or in between 2.2 to 2.9, or in between 2.2 to 2.8, or in between 2.3 to 2.8, or in between 2.3 to 2.7. In still another embodiment, it is in between 2.3 to 2.6, or in between 2.3 to 2.5, or in between 2.4 to 2.5.

In one embodiment, the OH value is in between 250 mg KOH/g to 400 mg KOH/g. In another embodiment, it is in between 260 mg KOH/g to 400 mg KOH/g, or in between 260 mg KOH/g to 390 mg KOH/g, or in between 270 mg KOH/g to 390 mg KOH/g, or in between 270 mg KOH/g to 380 mg KOH/g, or in between 280 mg KOH/g to 380 mg KOH/g. In yet another embodiment, it is in between 280 mg KOH/g to 370 mg KOH/g, or in between 290 mg KOH/g to 370 mg KOH/g, or in between 290 mg KOH/g to 360 mg KOH/g, or in between 295 mg KOH/g to 350 mg KOH/g, or in between 295 mg KOH/g to 340 mg KOH/g. In still another embodiment, is in between 295 mg KOH/g to 340 mg KOH/g, or in between 295 mg KOH/g to 330 mg KOH/g, or in between 295 mg KOH/g to 320 mg KOH/g, or in between 295 mg KOH/g to 310 mg KOH/g.

Suitable polyester polyols as second polyol in the embodiment 1 include those prepared by reacting a carboxylic acid and/or a derivative thereof or a polycarboxylic anhydride with a polyhydric alcohol. The polycarboxylic acids can be any of the known aliphatic, cycloaliphatic, aromatic, and/or heterocyclic polycarboxylic acids and can be substituted (e.g., with halogen atoms) and/or unsaturated. Examples of suitable polycarboxylic acids and anhydrides include oxalic acid, malonic acid, glutaric acid, pimelic acid, succinic acid, adipic acid, suberic acid, azelaic acid, sebacic acid, phthalic acid, isophthalic acid, terephthalic acid, trimellitic acid, trimellitic acid anhydride, pyromellitic dianhydride, phthalic acid anhydride, hexahydrophthalic acid anhydride, endomethylene tetrahydrophthalic acid anhydride, glutaric acid anhydride acid, maleic acid, maleic acid anhydride, fumaric acid, and dimeric and trimeric fatty acids, such as those of oleic acid which may be in admixture with monomeric fatty acids. Simple esters of polycarboxylic acids can also be used, such as terephthalic acid dimethylester, terephthalic acid bisglycol and extracts thereof. The polyhydric alcohols suitable for the preparation of polyester polyols can be aliphatic, cycloaliphatic, aromatic, and/or heterocyclic. The polyhydric alcohols optionally can include substituents which are inert in the reaction, for example, chlorine and bromine substituents, and/or may be unsaturated. Suitable amino alcohols, such as monoethanolamine, diethanolamine or the like can also be used. Examples of suitable polyhydric alcohols include ethylene glycol, propylene glycol, polyoxyalkylene glycols (such as diethylene glycol, polyethylene glycol, dipropylene glycol and polypropylene glycol), glycerol, and trimethylolpropane.

Other suitable polyester polyols include aromatic polyester polyols, e.g., those made by trans-esterifying polyethylene terephthalate (PET) scrap with a glycol such as diethylene glycol or made by reacting phthalic anhydride with a glycol. The resulting polyester polyols can be reacted further with ethylene and/or propylene oxide to form an extended polyester polyol containing additional internal alkyleneoxy groups.

In one embodiment, the polyester polyol is an aromatic polyester polyol selected from the list above. In another embodiment, the polyester polyol as second polyol in the embodiment 1 is an aromatic terephthalate polyester polyol with a nominal functionality in between 2.4 to 2.5 and OH value in between 295 mg KOH/g to 310 mg KOH/g.

Commercially available polyester polyols sold under the tradenames Stepanpol® PS from Stepan Company, Terol® from Huntsman, and Lupraphen® from BASF, may also be used.

The isocyanate reactive component in the embodiment 1 may further comprise a second polyether polyol as the second polyol. The second polyether polyol is different than the first polyether polyol.

In an embodiment, the second polyether polyol has a nominal functionality in between 3.5 to 8.0 and OH value in between 100 mg KOH/g to 450 mg KOH/g. In another embodiment, it is in between 3.5 to 7.9, or in between 3.5 to 7.7, or in between 3.5 to 7.5, or in between 3.5 to 7.3, or in between 3.5 to 7.1, or in between 3.5 to 7.0. In another embodiment, it is in between 3.6 to 7.0, or in between 3.6 to 6.8, or in between 3.6 to 6.6, or in between 3.6 to 6.4, or in between 3.6 to 6.2, or in between 3.6 to 6.0. In a still another embodiment, it is in between 3.7 to 5.9, or in between 3.7 to 5.7, or in between 3.7 to 5.5, or in between 3.7 to 5.3, or in between 3.7 to 5.1, or in between 3.7 to 5.0. In yet another embodiment, it is in between 3.8 to 5.0, or in between 3.8 to 4.9, or in between 3.8 to 4.8, or in between 3.9 to 4.7, or in between 3.9 to 4.5, or in between 3.9 to 4.4, or in between 3.9 to 4.3, or in between 3.9 to 4.2, or in between 3.9 to 4.1.

In an embodiment, the OH value is in between 140 mg KOH/g to 450 mg KOH/g, or in between 180 mg KOH/g to 450 mg KOH/g, or in between 220 mg KOH/g to 450 mg KOH/g, or in between 260 mg KOH/g to 450 mg KOH/g, or in between 300 mg KOH/g to 450 mg KOH/g. In another embodiment, it is in between 340 mg KOH/g to 450 mg KOH/g, or in between 380 mg KOH/g to 440 mg KOH/g, or in between 400 mg KOH/g to 440 mg KOH/g, or in between 410 mg KOH/g to 440 mg KOH/g, or in between 415 mg KOH/g to 435 mg KOH/g.

In one embodiment, the second polyether polyol as second polyol in the embodiment 1 is a Mannich polyol. Mannich polyol is an aromatic polyol obtained as a ring opening addition polymerization product of an alkylene oxide with a nitrogen-containing initiator. Suitable alkylene oxide include ethylene oxide, propylene oxide and mixtures thereof.

In another embodiment, the Mannich polyol has an ethylene oxide content in between 10 wt. % to 40 wt. %, or in between 10 wt. % to 30 wt. % based on the total amount of the alkylene oxide and is a ring-opening addition polymerization product of propylene oxide and ethylene oxide with a Mannich compound that is a reaction product of a phenol, an aldehyde, and an alkanolamine. Examples of phenol include phenol, nonylphenol, cresol, bisphenol A, and resorcinol. Examples of aldehyde include formaldehyde, and paraformaldehyde. Examples of the alkanolamine include monoethanolamine, diethanolamine, triethanolamine, 1-amino-2-propanol, and aminoethyl ethanolamine.

The isocyanate reactive component in the embodiment 1 may also comprise a polymer polyol as the second polyol. These polymer polyols may have a nominal functionality ranging between 2.0 to 8.0 and OH value ranging between 20 mg KOH/g to 1000 mg KOH/g.

In an embodiment, polymer polyols are stable dispersions of polymer particles in a polyol and thus are not prone to settling or floating. The polymer particles are chemically grafted to the polyol and act as a better reinforcement filler so that the composition of the polymer may be adjusted to give the desired properties. Polymer polyols have a very low moisture content and thus avoid the problems of wet fillers. The polymers in polymer polyols generally have a low density in comparison to inorganic fillers, such as clays or calcium carbonate.

Suitable polymer polyols are selected from styrene-acrylonitrile (SAN) polymer polyols, polyurea suspension (PHD) polymer modified polyols and polyisocyanate polyaddition (PIPA) polymer modified polyols.

SAN polymer polyols are known in the art and are disclosed in Ionescu's Chemistry and Technology of Polyols and Polyurethanes, 2nd Edition, 2016 by Smithers Rapra Technology Ltd. In the SAN polymer polyols, a carrier polyol is the polyol in which the in-situ polymerization of olefinically unsaturated monomers is carried out, while macromers are polymeric compounds which have at least one olefinically unsaturated group in the molecule and are added to the carrier polyol prior to the polymerization of the olefinically unsaturated monomers. The use and function of these macromers is described, for example, in U.S. Pat. Nos. 4,454,255, 4,458,038 and 4,460,715. The SAN polymer polyols are usually prepared by free-radical polymerization of the olefinically unsaturated monomers, preferably acrylonitrile and styrene, in a polyether polyol or polyester polyol, usually referred to as carrier polyol, as continuous phase. These polymer polyols are prepared by in-situ polymerization of acrylonitrile, styrene or mixtures of styrene and acrylonitrile, e.g. in a weight ratio of from 90:10 to 10:90 (styrene:acrylonitrile), using methods analogous to those described in DE 1111394, DE 1222669, DE 1152536 and DE 1152537. Moderators, also referred to as chain transfer agents, can also be used for preparing SAN polymer polyols. The use and the function of these moderators is described, for example, in U.S. Pat. No. 4,689,354, EP 0 365 986, EP 0 510 533 and EP 0 640 633, EP 008 444, EP 0731 118.

PHD polymer modified polyols are usually prepared by in-situ polymerization of an isocyanate mixture with a diamine and/or hydrazine in a polyol, e.g. a polyether polyol. Methods for preparing PHD polymer modified polyols are described in, for example, U.S. Pat. Nos. 4,089,835 and 4,260,530.

PIPA polymer modified polyols are usually prepared by the in-situ polymerization of an isocyanate mixture with a glycol and/or glycol amine in a polyol. Methods for preparing PIPA polymer modified polyols are described in, for example, U.S. Pat. Nos. 4,293,470 and 4,374,209.

In one embodiment, the second polyol in the isocyanate reactive component in the embodiment 1 comprises a mixture of the polyester polyol and the second polyether polyol, as described herein.

In another embodiment, the second polyol in the isocyanate reactive component in the embodiment 1 consists of a mixture of the polyester polyol and the second polyether polyol, as described herein.

Carbon Black (C)

In one embodiment, the carbon black in the embodiment 1 has a BET surface area in between 600 m²/g to 1200 m²/g, as determined according to ASTM D6556-19a. In another embodiment, the BET surface area is in between 700 m²/g to 1200 m²/g, or in between 700 m²/g to 1100 m²/g, or in between 800 m²/g to 1100 m²/g. In yet another embodiment, it is in between 800 m²/g to 1050 m²/g, or in between 900 m²/g to 1050 m²/g, or in between 950 m²/g to 1050 m²/g.

The electrical resistivity of the PU foam in the embodiment 1 in the static dissipative range, i.e. 1.0×10² Ω·m to 1.0×10⁹ Ω·m, as determined according to ASTM D257-14, is achieved by using effective amounts of the carbon black in the PU foam. In one embodiment, the carbon black is present in between 1.0 wt. % to 15.0 wt. % based on the total weight of the mixture. In another embodiment, it is present in between 2.0 wt. % to 15.0 wt. %, or in between 2.0 wt. % to 14.0 wt. %, or in between 3.0 wt. % to 14.0 wt. %. In yet another embodiment, it is present in between 3.0 wt. % to 13.0 wt. %, or in between 3.0 wt. % to 12.0 wt. %, or in between 3.0 wt. % to 11.0 wt. %.

In order to obtain the PU foam in the embodiment 1, carbon black may be added to A-side and/or B-side component. In an embodiment, the carbon black can be added to both A-side and B-side components, however, the amount of carbon black remains in between 1.0 wt. % to 15 wt. %, based on the total weight of the mixture. Carbon black in the mixture with less than 1.0 wt. % results in no change in the electrical resistivity of the PU foam, i.e. the resulting PU foam acts like an insulator with electrical resistivity more than 1.0×10⁹ Ω·m, as determined according to ASTM D257-14. While carbon black in quantities more than 15.0 wt. % results in a highly viscous system, which is very difficult to process using conventional techniques.

In the present context, A-side component includes the isocyanates and optionally the compounds which are non-reactive with the isocyanates, as described herein, for e.g. carbon black. Similarly, the B-side component includes the isocyanate reactive components. In an embodiment, the isocyanate reactive components include the first polyether polyol, carbon black, blowing agents, amine catalyst, and optionally the second polyol and/or additives, as described herein.

Commercially available carbon black fulfilling the above requirements can also be obtained under the tradename Printex® from Orion Engineered Carbons.

Blowing Agent (D)

In an embodiment, the blowing agent in the embodiment 1 can be selected from water, hydrocarbons, hydrofluorocarbons, hydrofluoroolefins, hydrochlorofluorocarbons, hydrochlorofluoroolefins, fluorocarbons, dialkyl ethers, cycloalkylene ethers and ketones, and fluorinated ethers. In another embodiment, the blowing agent in the embodiment 1 is selected from water and hydrofluorocarbons. In yet another embodiment, the blowing agent in the embodiment 1 is a mixture consisting of water and hydrofluorocarbons.

Suitable hydrocarbon blowing agents include lower aliphatic or cyclic, linear or branched hydrocarbons such as alkanes, alkenes and cycloalkanes, preferably having from 4 to 8 carbon atoms. Specific examples include n-butane, iso-butane, 2,3-dimethylbutane, cyclobutane, n-pentane, iso-pentane, technical grade pentane mixtures, cyclopentane, methylcyclopentane, neopentane, n-hexane, iso-hexane, n-heptane, iso-heptane, cyclohexane, methylcyclohexane, 1-pentene, 2-methylbutene, 3-methylbutene, 1-hexene and any mixture of the above.

Examples of suitable hydrofluorocarbons include 1,1,1,2-tetrafluoroethane (HFC 134a), 1,1,2,2-tetrafluoroethane, trifluoromethane, heptafluoropropane, 1,1,1-trifluoroethane, 1,1,2-trifluoroethane, 1,1,1,2,2-pentafluoropropane, 1,1,1,3-tetrafluoropropane, 1,1,1,3,3-pentafluoropropane (HFC 245fa), 1,1,3,3,3-pentafluoropropane, 1,1,1,3,3-pentafluoro-n-butane (HFC 365mfc), 1,1,1,4,4,4-hexafluoro-n-butane, and 1,1,1,2,3,3,3-heptafluoropropane (HFC 227ea). In one embodiment, the hydrofluorocarbon is 1,1,1,3,3-pentafluoropropane (HFC 245fa).

Examples of suitable hydrochlorofluorocarbons include 1-chloro-1,2-difluoroethane, 1-chloro-2,2-difluoroethane, 1-chloro-1,1-difluoroethane, 1,1-dichloro-1-fluoroethane and monochlorodifluoromethane.

Hydrofluoroolefins (HFOs), also known as fluorinated alkenes, that are suitable according to the present invention, are propenes, butenes, pentenes and hexenes having 3 to 6 fluorine substituents, while other substituents such as chlorine can be present, examples being tetra-fluoropropenes, fluorochloropropenes, for example trifluoromonochloropropenes, pentafluoro-propenes, fluorochlorobutenes, hexafluorobutenes or mixtures thereof. In one embodiment, the HFOs can be selected from cis-1,1,1,3-tetrafluoropropene, trans-1,1,1,3-tetrafluoropropene, 1,1,1-trifluoro-2-chloropropene, 1-chloro-3,3,3-trifluoropropene, 1,1,1,2,3-pentafluoropropene, in cis or trans form, 1,1,1,4,4,4-hexafluorobutene, 1-bromopentafluoropropene, 2-bromopentafluoropropene, 3-bromopentafluoropropene, 1,1,2,3,3,4,4-heptafluoro-1-butene, 3,3,4,4,5,5,5-heptafluoro-1-pentene, 1-bromo-2,3,3,3-tetrafluoropropene, 2-bromo-1,3,3,3-tetrafluoropropene, 3-bromo-1,1,3,3-tetrafluoropropene, 2-bromo-3,3,3-trifluoropropene, E bromo-3,3,3-trifluoropropene, 3,3,3-trifluoro-2-(trifluoromethyl)propene, 1-chloro-3,3,3-trifluoropropene, 2-chloro-3,3,3-trifluoropropene, and 1,1,1-trifluoro-2-butene.

In one embodiment, the blowing agent in the embodiment 1 is present in an amount in between 1.0 wt. % to 20.0 wt. % based on the total weight of the mixture. In another embodiment, it is present in between 2.0 wt. % to 20.0 wt. %, or in between 3.0 wt. % to 20.0 wt. %, or in between 4.0 wt. % to 20.0 wt. %. In yet another embodiment, it is present in between 5.0 wt. % to 19.0 wt. %, or in between 6.0 wt. % to 19.0 wt. %, or in between 7.0 wt. % to 19.0 wt. %, or in between 8.0 wt. % to 19.0 wt. %. In still another embodiment, it is present in between 9.0 wt. % to 18.0 wt. %, or in between 10.0 wt. % to 18.0 wt. %, or in between 11.0 wt. % to 17.0 wt. %, or in between 12.0 wt. % to 17.0 wt. %, or in between 13.0 wt. % to 17.0 wt. %.

Amine Catalyst (E)

In one embodiment, the amine catalyst in the embodiment 1 is selected from triethylamine, tributylamine, N-methylmorpholine, N-ethylmorpholine, N,N, N′,N′-tetramethylethylenediamine, pentamethyl-diethylenetriamine and higher homologues, 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether, and mixtures thereof.

In another embodiment, it is selected from N-ethylmorpholine, N,N, N′,N′-tetramethylethylenediamine, pentamethyl-diethylenetriamine and higher homologues, 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, and N,N-dimethyl-p-phenylethylamine.

In yet another embodiment, it is selected from N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, and N,N-diethyl-benzylamine.

In a further embodiment, the amine catalyst in the embodiment 1 is N,N-dimethylcyclohexylamine.

In one embodiment, the amine catalyst in the embodiment 1 is present in an amount in between 0.1 wt. % to 5.0 wt. % based on the total weight of the mixture. In another embodiment, it is present in between 0.5 wt. % to 5.0 wt. %, or in between 1.0 wt. % to 5.0 wt. %, or in between 2.0 wt. % to 5.0 wt. %. In still another embodiment, it is present in between 2.0 wt. % to 4.5 wt. %.

Additive (F)

The mixture in the embodiment 1 further comprises at least one additive (F) selected from flame retardants, surfactants, dispersing agents, and mixtures thereof.

Suitable compounds for use as flame retardants include phosphorus compounds, nitrogen compounds and mixtures thereof. In one embodiment, the phosphorus compounds are selected from tricresyl phosphate (TCP), tris(2-chloroethyl)phosphate (TCEP), tris(2-chloropropyl)phosphate (TCPP), tris(2,3-dibromopropyl)phosphate, tris(1,3-dichloropropyl)phosphate, tris(2-chloroisopropyl)phosphate, tricresylphosphate, tri(2,2-dichloroisopropyl)phosphate, diethylN,N-bis(2-hydryethyl)aminomethylphosphonate, dimethyl methylphosphonate, tri(2,3-dibromopropyl)phosphate, tri(1,3-dichloropropyl)phosphate, tetra-kis-(2-chloroethyl)ethylene diphosphate, triethylphosphate, diammonium phosphate, diethyl ethanephosphonate (DEEP), triethyl phosphate (TEP), dimethyl propanephosphonate (DMPP) and diphenyl cresyl phosphate (DPK). In another embodiment, the phosphorus compound is selected from TCP, TEP, TCEP, and TCPP. In yet another embodiment, it is selected from TCPP and TEP.

In another embodiment, the nitrogen compounds are selected from benzoguanamine, tris(hydroxyethyl)isocyanurate, isocyanurate, allantoin, glycoluril, melamine, melamine cyanurate, melamine polyphosphate, dimelamine phosphate, melamine pyrophosphate, melamine borate, ammonium polyphosphate, melamine ammonium polyphosphate, melamine ammonium pyrophosphate, condensation product of melamine selected from the group consisting of melem, melam, melon and higher condensed compounds and other reaction products of melamine with phosphoric acid and melamine derivatives.

In one embodiment, the flame retardant is present in the embodiment 1 in an amount in between 1.0 wt. % to 15.0 wt. %, based on the total weight of the mixture.

Suitable surfactants as additives in the embodiment 1 include silicone surfactants. The silicone surfactants is preferably used to emulsify the mixture as well as to control the size of the bubbles of the foam so that a foam of desired cell structure is obtained. Silicone surfactants for use in the preparation of PU foams in the embodiment 1 are available under a variety of tradenames known to those skilled in the art. Such materials have been found to be applicable over a wide range of formulations allowing uniform cell formation and maximum gas entrapment to achieve very low-density foam structure. In one embodiment, the silicone surfactant comprises a polysiloxane polyoxyalkylene block copolymer. Some representative silicone surfactants include Momentive's L-5130, L-5340, L-5440, L-6980, and L-6988; Air Products' DC-193, DC-197, DC-5582, and DC-5598; and Evonik's B-8404, B-8407, B-8409, and B-8462.

In another embodiment, the surfactant in the embodiment 1 is a non-silicone, non-ionic surfactant. Such surfactants are selected from oxyethylated alkylphenols, oxethylated fatty alcohols, paraffin oils, castor oil esters, ricinoleic acid esters, turkey red oil, groundnut oil, paraffins, and fatty alcohols. The preferred non-silicone non-ionic surfactants are Air Products' Dabco LK-221 and LK-443, and Dow's Vorasurf™ 504.

In another embodiment, the surfactant in the embodiment 1 is present in an amount in between 0.01 wt. % to 3.0 wt. %, based on the total weight of the mixture. In yet another embodiment, it is present in an amount in between 0.05 wt. % to 3.0 wt. %, or in between 0.075 wt. % to 2.5 wt. %, or in between 0.1 wt. % to 2.0 wt. %, or in between 0.5 wt. % to 1.5 wt. %.

In an embodiment, dispersing agent as additives in the embodiment 1 include polymeric dispersants, for example, a polyester-based polymer dispersant, the dispersant is an acrylic polymer, polyurethane-based polymer dispersant, polyallylamine-based polymer dispersant, carbodiimide-based polymer dispersant, and a polyamide-based polymer dispersant. In another embodiment, the dispersing agent is selected from acrylic-based polymer dispersant and polyamide-based polymer dispersant.

Polyamide-based polymer dispersant include a polyester chain and side chain having a plurality of comb structure. In one embodiment, a large number of polyalkyleneimine in its main chain structure having a nitrogen atom, said nitrogen atom via an amide bond to the side chain of the polyester having a plurality of compounds are preferred. Such a polyamide-based polymer dispersant of a comb structure is also available under the tradename of DISPERBYK® from BYK Chemie Co and SOLSPERSE from Lubrizol.

In one embodiment, the dispersing agent is present in the embodiment 1 in an amount in between 0.1 wt. % to 15.0 wt. %, based on the total weight of the mixture. In another embodiment, it is present in between 0.1 wt. % to 12.0 wt. %, or 0.1 wt. % to 10.0 wt. %. In still another embodiment, it is present in between 0.1 wt. % to 9.0 wt. %, or 0.1 wt. % to 8.0 wt. %. In yet another embodiment, it is present in between 0.1 wt. % to 7.0 wt. %, or 0.1 wt. % to 6.0 wt. %, or 0.1 wt. % to 5.0 wt. %.

In an embodiment, the additives may be added to the A-side or B-side component, as long as they do not have a detrimental effect on the properties of the PU foam. In one embodiment, the additives are added to the B-side component.

In another embodiment, the mixture in the embodiment 1 may further comprise auxiliaries (G) selected from alkylene carbonates, carbonamides, pyrrolidones, dyes, pigments, IR absorbing materials, UV stabilizers, fungistats, bacterio-stats, hydrolysis controlling agents, curing agents, antioxidants, and cell regulators. Suitable amount of these auxiliaries includes 0.1 wt. % to 20 wt. %, based on the total weight of the mixture. Further details regarding these auxiliaries can be found, for example, in Kunststoffhandbuch, Volume 7, “Polyurethane” Carl-Hanser-Verlag Munich, 1^{st} edition, 1966, 2^{nd} edition, 1983 and 3^{rd} edition, 1993. These ingredients may be added to the A-side or B-side component, as long as they do not have a detrimental effect on the properties of the PU foam.

Process

Another aspect of the present invention is embodiment 2, directed towards a process for preparing the PU foam in the embodiment 1. The foam-forming process may be carried out batchwise, semi-continuously or continuously. In one embodiment, the isocyanate component (A) is reacted with the isocyanate reactive component (B) in the presence of carbon black (C), at least one blowing agent (D), at least one amine catalyst (E) and optionally at least one additive (F) and/or auxiliaries (G), as described herein.

In an embodiment, the isocyanate component (A) and the isocyanate reactive component (B) are mixed at an index in between 70 to 120. In another embodiment, the index is in between 80 to 120, or in between 80 to 110, or in between 90 to 110. In the present context, the index of 100 corresponds to one isocyanate group per one isocyanate reactive group.

In one embodiment, the carbon black (C) is added to the at least one isocyanate component (A) and/or the at least one isocyanate reactive component (B) prior to mixing. In another embodiment, (C), (D), (E) and optionally (F) and/or (G) are added to (B), prior to mixing. Said otherwise, the ingredients (C), (D), (E), optionally (F) and/or (G) are pre-mixed together with (B), for example in a mixing head, and then mixed with (A).

In another embodiment, when the carbon black is added to the at least one isocyanate component (A) and/or the at least one isocyanate reactive component (B) prior to mixing, the amount is based on the total weight of the respective component. For e.g. if the carbon black is added to the A-side, the amount added is in between 1.0 wt. % to 15.0 wt. % based on the total weight of the A-side. Similarly, if the carbon black is added to the B-side, the amount added is in between 1.0 wt. % to 15.0 wt. % based on the total weight of the B-side. Further, the amount added may also vary as disclosed in the embodiment 1, as above. Also, the ingredients (C), (D), (E), optionally (F) and/or (G) when pre-mixed to the B-side may be added in their respective amounts, as disclosed in the embodiment 1.

In an embodiment, the ingredients (A), (B), C), (D), (E), and optionally (F) and/or (G) in the embodiment 1 are mixed at temperature in between 10° C. to 50° C. for the PU foam forming reaction to start. It is usually not necessary to apply heat to the mixture to drive the cure, but this may be done too, if desired.

The mixture in the embodiment 1 can be employed for pour-in-place applications or spray applications. In one embodiment, the mixture is useful for pour-in-place applications, wherein it is dispensed into a cavity and foams within the cavity to fill it and provide structural attributes and desired electrical resistivity to an assembly. The term “pour-in-place” refers to the fact that the foam is created at the location, where it is needed, rather than being created in one step and later assembled into place in a separate manufacturing step. Further, the term “cavity” refers to an empty or hollow space of any geometry having at least one open side into which the mixture can be dispensed at conditions such that expansion and curing of the composition occurs to form the PU foam in the embodiment 2.

In another embodiment, the mixture is useful for spray applications. Spraying techniques are used for filling molds and panels and for applying the mixture to plane surfaces. Spraying is particularly useful in applications, where large areas are involved, such as tanks or building walls. Sprayed PU foam coatings provide both physical strength and improved insulation. In spray applications, the mixing is accomplished by atomization. By the term “atomization”, it is referred to the particles or droplets of the mixture obtained from suitable spraying means, such as not limited to, a nozzle or an atomizer.

In one embodiment, each of the isocyanate component (A) and the isocyanate reactive component (B), with ingredients (C), (D), (E) and optionally (F) and/or (G) pre-mixed to either A-side and/or B-side, are fed as a separate streams, for instance, in a mixing device. In one embodiment, the presently claimed invention refers to the two-component system (namely A-side and B-side), as described herein. However, it is possible that a multi-component system can also be used. By the term “multicomponent system”, it is referred to any number of streams, at least more than the conventionally existing two streams in the two-component system. For example, three, four, five, six or seven, separate streams can be fed to the mixing device.

These additional streams can comprise one or more selected from (A), (B), (C), (D), (E), (F) and (G), as described herein. In one embodiment, each of the streams in the multicomponent system is different from the A-side and B-side component streams. Hereinafter, the A-side component can be interchangeably also referred as first stream, while the B-side component as second stream.

Suitable mixing devices for the purpose of the presently claimed invention are well known to the person skilled in the art, for example, a mixing head or a static mixer. While it is preferred that each stream enters separately in the mixing device, it is possible that the components within each stream are well mixed by suitable mixing means, for example, the static mixer. Static mixers are well known to the person skilled in the art for mixing of liquids, for example, as described in EP 0 097 458. Typically, the static mixers are tubular apparatuses with fixed internals which serve for the mixing of individual stream across the cross section of the tube. Static mixers can be used in continuous process for the conduct of various operations, for example, mixing, substance exchange between two phases, chemical reactions or heat transfer. The homogenization of the streams is brought about via a pressure gradient produced by means of a pump.

Suitable temperatures for PU foam processing are well known to the person skilled in the art. In an embodiment, in the mixing device and/or the individual streams, a temperature in between 10° C. to 50° C., or in between 15° C. to 40° C. can be maintained. However, each stream can be maintained at a different temperature and each stream does not necessarily have the same temperature. For instance, the temperature of the first stream can be 20° C., while that of the second stream can be 30° C.

In an embodiment, feeding of the streams into the mixing device is conducted preferably by means of pumps, which can operate at low-pressure or high-pressure, preferably at high pressure, in order to dispense the streams into the mixing device. Mixing within the mixing devices can be achieved among others by simple static mixer, low-pressure dynamic mixers, rotary element mixer as well as high-pressure impingement mixer. Mixing can be controlled by suitable means known to the person skilled in the art, for instance by simply switching on and off or even by a process control software equipped with flow meters, so that parameters, such as mixing ratio or temperature can be controlled.

In the present context, the term “low pressure” refers to pressure in between 0.1 MPa to 5 MPa, while “high pressure” refers to pressure above 5 MPa, preferably in between 5 MPa to 26 MPa.

In an embodiment, the ingredients (A), (B), (C), (D), (E), and optionally (F) and/or (G) are mixed in suitable mixing devices in any sequence. For instance, the ingredients can be added to the mixing device all at once or one by one or as pre-mixture of any of these ingredients and in combinations thereof. In another embodiment, the mixing in the embodiment 1 or 2 is carried out at rpm ranging between 500 rpm to 5000 rpm and for suitable duration known to the person skilled in the art.

In one embodiment, the PU foam in the embodiment 1 or as obtained in the embodiment 2 has the desired electrical resistivity in the static dissipative range, i.e. 1.0×10² Ω·m to 1.0×10⁹ Ω·m, as determined according to ASTM D257-14. This renders the PU foam useful for applications including any relevant product requiring efficient electrical dissipation and the electro-magnetic shielding, such as, but not limited to, filled materials and composites for structural and decorative applications. Examples may include, but are not limited to wind turbine blades, airplane wings, and automotive parts. In other instances, such substantially electrically conductive PU-based materials may also target applications where metals have currently been used and where electro-magnetic shielding is required. The PU foam also has acceptable thermal conductivity values (or k-factor), in addition to the mechanical properties, which render it useful for insulation applications as well.

The acceptable mechanical properties of the PU foam of the embodiment 1 or 2 include such as, but not limited to, compressive strength, storage modulus, damping factor and damping capacity, Young's modulus, hardness, elongation at break, and tensile strength. Some of these have been reported in the example section below.

In another embodiment, the PU foam in the embodiment 1 or as obtained in the embodiment 2 is not used in electronics-manufacturing facility as well as in shipping electronic devices, such as the ones described in U.S. Pat. No. 4,231,901.

Another aspect of the present invention is embodiment 3, directed towards the use of the PU foam in the embodiment 1 or as obtained in the embodiment 2 for static dissipative materials. Particularly, the static dissipative materials include cathodic protection systems, such as trench breakers or pipeline pillows.

The PU foam of the embodiment 1 or as obtained according to embodiment 2 can facilitate the construction and/or placement of new underground pipelines in terms of serving as three-dimensional pads and/or pillows which, as sprayed directly on and around an underground structure in place, may physically support, stabilize and protect the carbon steel structure as placed in an underground trench. The PU foam can further be spray applied to produce trench breakers which as applied in intermittent locations along underground trench may negotiate erosion of the trench created for installing a particular underground hazardous liquid or natural gas pipeline facility. The proficient installation of the PU foam offers several attributes with respect to reduced labour cost, reduced risk of employee injury (and even death) versus use of sandbags and increased productivity resulting from much faster jobsite completion.

Another aspect of the present invention is embodiment 4, directed towards a method for producing a composite structure comprising the PU foam of embodiment 1 or as obtained according to embodiment 2, said method comprising: (M1) curing the mixture to obtain the composite structure which comprises a direct current electrical conductivity configured to conduct a provided current from an impressed current cathodic protection.

In an embodiment, the step (M1) in the embodiment 4 comprises the following sub-steps: (M11) adding one or more of the carbon black (C), blowing agent (D), amine catalyst (E) and optionally additives (F) to the isocyanate component (A) and/or the isocyanate reactive component (B), (M12) mixing the at least one isocyanate component (A) and/or the at least one isocyanate reactive component (B) of step (M11) to obtain the mixture, and (M12) curing the mixture.

In one embodiment, carbon black (C) is added to the isocyanate component (A) and the isocyanate reactive component (B) in step (M11) in the embodiment 4. In another embodiment, the amount of carbon black (C) in the isocyanate component (A) is different than the amount of carbon black (C) in the isocyanate reactive component (B). In still another embodiment, the amount of carbon black (C) in the isocyanate component (A) and the isocyanate reactive component (B) is same.

In another embodiment, the composite structure in the embodiment 4 comprises an electrically conductive pad, pillow or trench breaker for use in underground oil and gas pipeline facilities construction.

Another aspect of the present invention is embodiment 5, directed towards a trench breaker or pipeline pillow comprising the PU foam of embodiment 1 or as obtained in the embodiment 2. Yet another aspect of the present invention is embodiment 6, directed towards a method of supporting trench pipes comprising:

(T1) inserting into a trench in which or to which a pipe is to be or has been placed, the PU foam of the embodiment 1 or 2, and

(T2) backfilling the trench after the foam and the pipe have been inserted into the trench.

Illustrative embodiments of the present invention are listed below, but do not restrict the present invention. In particular, the present invention also encompasses those embodiments that result from the dependency references and hence combinations specified hereinafter. More particularly, in the case of naming of a range of embodiments hereinafter, for example the expression “The process according to any of embodiments 1 to 4”, should be understood such that any combination of the embodiments within this range is explicitly disclosed to the person skilled in the art, meaning that the expression should be regarded as being synonymous to “The process according to any of embodiments 1, 2, 3 and 4”:
I. A polyurethane foam which is obtained by reacting a mixture comprising:
   (A) at least one isocyanate component,
   (B) at least one isocyanate reactive component comprising a first polyether polyol having a nominal functionality in between 2.0 to 3.5 and OH value in between 450 mg KOH/g to 600 mg KOH/g,
   (C) carbon black having a BET surface area in between 600 m²/g to 1200 m²/g
   (D) at least one blowing agent, and
   (E) at least one amine catalyst,
wherein the amount of carbon black (C) is in between 1.0 wt. % to 15.0 wt. % based on the total weight of the mixture.
II. The polyurethane foam according to embodiment I, wherein no carbon nanotube or graphite or graphene is present.
III. The polyurethane foam according to embodiment I or II, wherein the polyurethane foam is a rigid polyurethane foam.
IV. The polyurethane foam according to one or more of embodiments I to III, wherein the isocyanate component is selected from methylene diphenyl diisocyanate and polymeric methylene diphenyl diisocyanate.
V. The polyurethane foam according to one or more of embodiments I to IV, wherein the first polyether polyol has a nominal functionality in between 2.7 to 3.1 and OH value in between 480 mg KOH/g to 530 mg KOH/g.
VI. The polyurethane foam according to one or more of embodiments I to V, wherein the isocyanate reactive component comprises a second polyol selected from a polyester polyol, a second polyether polyol, a polymer polyol, and a mixture thereof.
VII. The polyurethane foam according to embodiment VI, wherein the polyester polyol has a nominal functionality in between 1.9 to 3.5 and OH value in between 250 mg KOH/g to 400 mg KOH/g.
VIII. The polyurethane foam according to embodiment VI or VII, wherein the polyester polyol has a nominal functionality in between 2.3 to 2.7 and OH value in between 295 mg KOH/g to 320 mg KOH/g.
IX. The polyurethane foam according to one or more of embodiments VI to VIII, wherein the polyester polyol is an aromatic polyester polyol.
X. The polyurethane foam according to one or more of embodiments VI to IX, wherein the second polyether polyol has a nominal functionality in between 3.5 to 8.0 and OH value in between 100 mg KOH/g to 450 mg KOH/g.
XI. The polyurethane foam according to one or more of embodiments VI to X, wherein the second polyether polyol has a nominal functionality in between 3.8 to 5.0 and OH value in between 380 mg KOH/g to 440 mg KOH/g.
XII. The polyurethane foam according to one or more of embodiments VI to XI, wherein the second polyether polyol is a Mannich polyol.
XIII. The polyurethane foam according to embodiment XII, wherein the Mannich polyol is a ring opening addition polymerization product of an alkylene oxide with a nitrogen-containing initiator.
XIV. The polyurethane foam according to embodiment XII or XIII, wherein the Mannich polyol has an ethylene oxide content in between 10 wt. % to 40 wt. % based on the total amount of the alkylene oxide and is a ring-opening addition polymerization product of propylene oxide and ethylene oxide with a Mannich compound that is a reaction product of a phenol, an aldehyde, and an alkanolamine.
XV. The polyurethane foam according to one or more of embodiments VI to XIV, wherein the polymer polyol has a nominal functionality ranging between 2.0 to 8.0 and OH value ranging between 20 mg KOH/g to 1000 mg KOH/g.
XVI. The polyurethane foam according to one or more of embodiments I to XV, wherein the carbon black has a BET surface area in between 900 m²/g to 1050 m²/g.
XVII. The polyurethane foam according to one or more of embodiments I to XVI, wherein the amount of carbon black is in between 3.0 wt. % to 11.0 wt. % based on the total weight of the mixture.
XVIII. The polyurethane foam according to one or more of embodiments I to XVII, wherein the blowing agent is selected from water, hydrocarbons, hydrofluorocarbons, hydrofluoroolefins, hydrochlorofluorocarbons, hydrochlorofluoroolefins, fluorocarbons, dialkyl ethers, cycloalkylene ethers and ketones, and fluorinated ethers.
XIX. The polyurethane foam according to one or more of embodiments I to XVIII, wherein the blowing agent is selected from water and hydrofluorocarbons.
XX. The polyurethane foam according to embodiment XVIII or XIX, wherein the hydrofluorocarbon is selected from of 1,1,1,2-tetrafluoroethane (HFC 134a), 1,1,2,2-tetrafluoroethane, trifluoromethane, heptafluoropropane, 1,1,1-trifluoroethane, 1,1,2-trifluoroethane, 1,1,1,2,2-pentafluoropropane, 1,1,1,3-tetrafluoropropane, 1,1,1,3,3-pentafluoropropane (HFC 245fa), 1,1,3,3,3-pentafluoropropane, 1,1,1,3,3-pentafluoro-n-butane (HFC 365mfc), 1,1,1,4,4,4-hexafluoro-n-butane, and 1,1,1,2,3,3,3-heptafluoropropane (HFC 227ea).
XXI. The polyurethane foam according to one or more of embodiments XVIII to XX, wherein the hydrofluorocarbon is 1,1,1,3,3-pentafluoropropane (HFC 245fa).
XXII. The polyurethane foam according to one or more of embodiments I to XXI, wherein the blowing agent is present in an amount in between 1 wt. % to 20 wt. % based on the total weight of the mixture.
XXIII. The polyurethane foam according to one or more of embodiments I to XXII, wherein the amine catalyst is selected from triethylamine, tributylamine, N-methylmorpholine, N-ethylmorpholine, N,N, N′,N′-tetramethylethylenediamine, pentamethyl-diethylenetriamine and higher homologues, 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether, and mixtures thereof.
XXIV. The polyurethane foam according to one or more of embodiments I to XXIII, wherein the amine catalyst is N,N-dimethylcyclohexylamine.
XXV. The polyurethane foam according to one or more of embodiments I to XIV, wherein the amine catalyst is present in an amount in between 0.1 wt. % to 5.0 wt. % based on the total weight of the mixture.
XXVI. The polyurethane foam according to one or more of embodiments I to XV, wherein the mixture further comprises at least one additive (F) selected from flame retardants, surfactants, dispersing agents, and mixtures thereof.
XXVII. The polyurethane foam according to embodiment XXVI, wherein the flame retardant is a phosphorus-based flame retardant.
XXVIII. The polyurethane foam according to embodiment XXVI or XVII, wherein the flame retardant is selected from tricresyl phosphate (TCP), triethyl phosphate (TEP), tris(β-chloroethyl) phosphate (TCEP), tris(δ-chloropropyl) phosphate (TCPP), and mixtures thereof.
XXIX. The polyurethane foam according to one or more of embodiments XXVI to XVIII, wherein the flame retardant is selected from tris(β-chloropropyl) phosphate (TCPP) and triethyl phosphate (TEP).
XXX. The polyurethane foam according to one or more of embodiments XXVI to XXIX, wherein the flame retardant is present in an amount in between 1.0 wt. % to 15.0 wt. %, based on the total weight of the mixture.
XXXI. The polyurethane foam according to one or more of embodiments XXVI to XXX, wherein the surfactant is a non-silicone, non-ionic surfactant.
XXXII. The polyurethane foam according to one or more of embodiments XXVI to XXXI, wherein the surfactant is selected from oxyethylated alkylphenols, oxethylated fatty alcohols, paraffin oils, castor oil esters, ricinoleic acid esters, turkey red oil, groundnut oil, paraffins, and fatty alcohols.
XXXIII. The polyurethane foam according to one or more of embodiments XXVI to XXXII, wherein the surfactant is present in an amount in between 0.01 wt. % to 3.0 wt. %, based on the total weight of the mixture.
XXXIV. The polyurethane foam according to one or more of embodiments XXVI to XXXIII, wherein the dispersing agent is selected from a polyester-based polymer, acrylic polymer, polyurethane-based polymer, polyallylamine-based polymer, carbodiimide-based, polyamide-based polymer, and mixtures thereof.
XXXV. The polyurethane foam according to one or more of embodiments XXVI to XXXIV, wherein the dispersing agent is a polyamide-based polymer dispersant.
XXXVI. The polyurethane foam according to one or more of embodiments XXVI to XXXV, wherein the dispersing agent is present in an amount in between 0.1 wt. % to 15.0 wt. %, based on the total weight of the mixture.
XXXVII. The polyurethane foam according to one or more of embodiments I to XXXVI having a foam density in between 30 kg/m³ to 150 kg/m³ determined according to ASTM D1622 and an electrical resistivity in between 1.0×10² Ω·m to 1.0×10⁹ Ω·m determined according to ASTM D257-14.
XXXVIII. A process for preparing the polyurethane foam according to one or more of embodiments I to XXXVII.
XXXIX. The process according to embodiment XXXVIII, wherein the isocyanate component (A) is reacted with the isocyanate reactive component (B) in the presence of carbon black (C), at least one blowing agent (D), at least one amine catalyst (E) and optionally at least one additive (F).
XL. The process according to embodiment XXXVIII or XXXIX, wherein the isocyanate component (A) and the isocyanate reactive component (B) are mixed at an index in between 70 to 120.
XLI. The process according to one or more of embodiments XXXVIII to XL, wherein the carbon black (C) is added to the at least one isocyanate component (A) and/or the at least one isocyanate reactive component (B) prior to mixing.
XLII. Use of the polyurethane foam according to one or more of embodiments I to XXXVII for static dissipative materials.
XLIII. The use according to embodiment XLII, wherein the static dissipative material comprises trench breaker or pipeline pillow.
XLIV. A method for producing a composite structure comprising the polyurethane foam according to one or more of embodiments I to XXXVII or as obtained according to one or more of embodiments XXXVIII to XLI, said method comprising: (M1) curing the mixture to obtain the composite structure which comprises a direct current electrical conductivity configured to conduct a provided current from an impressed current cathodic protection.
XLV. The method according to embodiment XLIV, wherein the step (M1) comprises the following sub-steps:
   (M11) adding one or more of the carbon black (C), blowing agent (D), amine catalyst (E) and optionally the additives (F) to the at least one isocyanate component (A) and/or the at least one isocyanate reactive component (B),
   (M12) mixing the at least one isocyanate component (A) and/or the at least one isocyanate reactive component (B) of step (M11) to obtain the mixture, and
   (M13) curing the mixture.
XLVI. The method according to embodiment XLIV or XLV, wherein the composite structure comprises an electrically conductive pad, pillow or trench breaker for use in underground oil and gas pipeline facilities construction.
XLVII. A trench breaker or pipeline pillow comprising the polyurethane foam according to one or more of embodiments I to XXXVII or as obtained according to one or more of embodiments XXXVIII to XLI.
XLVIII. A method of supporting trench pipes comprising:
   (T1) inserting into a trench in which or to which a pipe is to be or has been placed, the polyurethane foam according to one or more of embodiments I to XXXVII or as obtained according to one or more of embodiments XXXVIII to XLI, and
   (T2) backfilling the trench after the foam and the pipe have been inserted into the trench.

### EXAMPLES

The presently claimed invention is illustrated by the non-restrictive examples which are as follows:

Raw Materials

POLYOL (P)

| | |
|---|---|
| P1 | Polyether polyol based on ethanolamine initiator and a mixture of ethylene oxide |
| | and propylene oxide, having a nominal functionality ranging between 2.9 to 3.1 |
| | and OH value in between 490 mg KOH/g to 520 mg KOH/g, obtained from BASF |

ISOCYANATE (ISO)

| | |
|---|---|
| ISO 1 | Polymeric MDI with NCO content of 31.5 wt.-% and functionality = 2.7, obtained |
| | from BASF |

CARBON BLACK (CB)

| | |
|---|---|
| CB 1 | Carbon black having a BET surface area of 1000 m²/g, obtained from Orion |
| | Engineered Carbons |
| CB 2 | Carbon black having BET surface area of 235 m²/g, obtained from Cabot |
| | Corporation |
| CB 3 | Commercially available carbon black having BET surface area of 58.5 m²/g, |
| | obtained from Alfa Aesar |

BLOWING AGENT (BA)

| | |
|---|---|
| BA 1 | Water |
| BA 2 | 1,1,1,3,3-pentafluoropropane (HFC 245fa), obtained from Honeywell |

AMINE CATALYST (AC)

| | |
|---|---|
| AC 1 | N,N-Dimethylcyclohexylamine, obtained from Sigma Aldrich |

ADDITIVE PACKAGE (AP)

| | |
|---|---|
| AP 1 | Flame retardant-TCPP |
| | Surfactant-Dabco LK-221 from Air Products |
| | Bis-oct |

Standard Method

| | |
|---|---|
| DIN 53240 | OH value |
| ASTM D257-14 | Electrical resistivity |
| ASTM D1622 | Foam density |
| ASTM D6556-19a | BET surface area |
| ASTM D1621-16 | Compressive strength |

General Synthesis of Mixture for Producing PU Foam

The aforementioned raw materials were added in the amounts mentioned in Table 1 in both the A-side and B-side components (all in wt. %). Both the A-side and B-side components were then added to a mixing cup and subjected to mixing at rpm of 3000 to obtain a desired index. The temperature of A-side and B-side components was maintained between 25° C. to 30° C.

The PU foams thus obtained were subsequently cut into samples of 50 mm×10 mm discs and the properties determined are reported in Table 1 and 2 below.

TABLE 1
Inventive and comparative examples

| | | | | | |
|---|---|---|---|---|---|
| Ingredient | CE 1 | IE 1 | IE 2 | CE 2 | CE3 |

A-side component (wt. %)

| | | | | | |
|---|---|---|---|---|---|
| ISO 1 | 100 | 96.25 | 96 | 100 | 100 |
| CB 1 | — | 3.75 | 4.0 | — | — |
| Viscosity | 206 | n.d. | 6579 | n.d. | n.d. |
| mPas at 15° C. | | | | | |

B-side component (wt. %)

| | | | | | |
|---|---|---|---|---|---|
| P1 | 70.47 | 67.91 | 67.74 | 67.33 | 67.33 |
| AC 1 | 4.00 | 3.86 | 3.85 | 3.98 | 3.98 |
| CB 1 | — | 3.64 | 3.87 | — | — |
| AP 1 | 10.64 | 10.25 | 10.23 | 10.57 | 10.57 |
| BA 2 | 13.09 | 12.61 | 12.58 | 12.98 | 12.98 |
| BA 1 | 1.79 | 1.73 | 1.73 | 1.77 | 1.77 |
| CB 2 | — | — | — | 3.37 | — |
| CB 3 | — | — | — | — | 3.37 |
| Viscosity | 88 | n.d. | 3623 | 654 | 1530 |
| mPas at 15° C. | | | | | |

PU foam

| | | | | | |
|---|---|---|---|---|---|
| Index | 101 | 106 | 105 | 107 | 107 |
| Density | 27-40 | 27-40 | 27-40 | 33.00 | 35.56 |
| kg/m³ | | | | | |
| Electrical | 6.40 × 10¹¹ | 8.88 × 10⁵ | 3.78 × 10⁷ | 6.81 × 10¹¹ | 9.41 × 10¹¹ |
| resistivity | | | | | |
| Ω·m | | | | | |
| Compressive | >124,000 | >124,000 | >124,000 | n.d. | n.d. |
| strength, Pa | | | | | |

n.d. = not determined

TABLE 2
Effect of carbon black on electrical resistivity

| | | | |
|---|---|---|---|
| Ingredient | CE 4 | CE 5 | IE 3 |

A-side component (wt. %)

| | | | |
|---|---|---|---|
| ISO 1 | 100 | 100 | 100 |
| CB 1 | — | — | — |

B-side component (wt. %)

| | | | |
|---|---|---|---|
| P1 | 64.37 | 64.37 | 64.37 |
| AC 1 | 3.98 | 3.98 | 3.98 |
| CB 1 | — | — | 6.44 |
| CB 2 | — | 6.44 | — |
| CB 3 | 6.44 | — | — |
| AP 1 | 10.57 | 10.57 | 10.57 |
| BA 2 | 12.88 | 12.88 | 12.88 |
| BA 1 | 1.77 | 1.77 | 1.77 |
| Viscosity, | >100,000 | >100,000 | >100,000 |
| mPas at 15° C. | | | |

PU foam

| | | | |
|---|---|---|---|
| Index | 110 | 110 | 110 |
| Density, kg/m³ | 30.92 | 35.32 | 38.04 |
| Electrical resistivity, | 6.86 × 10¹¹ | 5.83 × 10¹¹ | 1.26 × 10⁵ |
| Ω·m | | | |

As evident in Tables 1 and 2, the absence of carbon black in CE 1 does not result in the electrical resistivity in the static dissipative range but was more insulative. However, the presence of carbon black CB 1 in A-side and/or B-side results in substantial improvement in the electrical resistivity. Particularly, IE 1 and IE 2 disclosing carbon black in A-side as well as B-side, and IE 3 disclosing carbon black in only B-side result in electrical resistivity in the static dissipative range. Further, the inventive PU foams had acceptable or similar compressive strength, as the comparative PU foams.

Furthermore, when equal amounts of carbon blacks, but with different BET surface areas, were added to the mixture or in the B-side, the resulting PU foam had different electrical resistivities. As shown in Table 2, only IE 3 having carbon black with BET surface area as per the present invention was able to showcase electrical resistivity in the static dissipative range, while CE 4 and CE 5 were insulative in nature, i.e. electrical resistivity in magnitude much higher than 1.0×10⁹ Ω·m.

Thus, the present invention PU foam is suitable for applications described hereinabove, for e.g. trench breakers or pipeline pillows.

1. A polyurethane foam which is obtained by reacting a mixture comprising:
(A) at least one isocyanate component,
(B) at least one isocyanate reactive component comprising a first polyether polyol having a nominal functionality in between 2.0 to 3.5 and an OH value in between 450 mg KOH/g to 600 mg KOH/g,
(C) carbon black having a BET surface area in between 600 m²/g to 1200 m²/g,
(D) at least one blowing agent, and
(E) at least one amine catalyst,
wherein an amount of carbon black (C) is in between 1.0 wt. % to 15.0 wt. % based on a total weight of the mixture.

2. The polyurethane foam according to claim 1, wherein the at least one isocyanate component is selected from the group consisting of methylene diphenyl diisocyanate and polymeric methylene diphenyl diisocyanate.

3. The polyurethane foam according to claim 1, wherein the carbon black has a BET surface area in between 900 m²/g to 1050 m²/g.

4. The polyurethane foam according to claim 1, wherein the amount of carbon black is in between 3.0 wt. % to 11.0 wt. % based on the total weight of the mixture.

5. The polyurethane foam according to claim 1, wherein the blowing agent is selected from the group consisting of water and hydrofluorocarbons.

6. The polyurethane foam according to claim 1, wherein the mixture further comprises at least one additive (F) selected from the group consisting of flame retardants, surfactants, dispersing agents, and mixtures thereof.

7. The polyurethane foam according to claim 1, wherein the polyurethane foam has a foam density in between 30 kg/m³ to 150 kg/m³ determined according to ASTM D1622 and an electrical resistivity in between 1.0×10² Ω·m to 1.0×10⁹ Ω·m determined according to ASTM D257-14.

8. A process for preparing the polyurethane foam according to claim 1.

9. The process according to claim 8, wherein the at least one isocyanate component (A) and the at least one isocyanate reactive component (B) are mixed at an index in between 70 to 120.

10. A method of using the polyurethane foam according to claim 1, the method comprising using the polyurethane foam for static dissipative materials.

11. The method according to claim 10, wherein the static dissipative materials comprise a trench breaker or a pipeline pillow.

12. A method for producing a composite structure comprising the polyurethane foam according to claim 1, said method comprising:
(M1) curing the mixture to obtain the composite structure which comprises a direct current electrical conductivity configured to conduct a provided current from an impressed current cathodic protection.

13. The method according to claim 12, wherein the composite structure comprises an electrically conductive pad, a pillow or a trench breaker for use in underground oil and gas pipeline facilities construction.

14. A trench breaker or a pipeline pillow comprising the polyurethane foam according to claim 1.

15. A method of supporting trench pipes comprising:
(T1) inserting into a trench in which or to which a pipe is to be or has been placed, the polyurethane foam according to claim 1, and
(T2) backfilling the trench after the foam and the pipe have been inserted into the trench.

16. A method of supporting trench pipes comprising:
(T1) inserting into a trench in which or to which a pipe is to be or has been placed, the polyurethane foam as obtained according to claim 8, and
(T2) backfilling the trench after the foam and the pipe have been inserted into the trench.

17. A method of using the polyurethane foam as obtained according to claim 8, the method comprising using the polyurethane foam for static dissipative materials.

18. A method for producing a composite structure comprising the polyurethane foam as obtained according to claim 8, said method comprising:
(M1) curing the mixture to obtain the composite structure which comprises a direct current electrical conductivity configured to conduct a provided current from an impressed current cathodic protection.

19. The method according to claim 18, wherein the composite structure comprises an electrically conductive pad, a pillow or a trench breaker for use in underground oil and gas pipeline facilities construction.

20. A trench breaker or a pipeline pillow comprising the polyurethane foam as obtained according to claim 8.
